(19) United States
(12) Patent Application Publication
(10) Pub. No.: US 2025/0348033 A1
(43) Pub. Date: Nov. 13, 2025

(54) IMAGE FORMING APPARATUS AND IMAGE FORMING METHOD

(71) Applicant: KYOCERA Document Solutions Inc., Osaka (JP)

(72) Inventors: Kazuto Misu, Osaka (JP); Masahiro Nishiyama, Osaka (JP); Koji Maeda, Osaka (JP)

(21) Appl. No.: 19/204,958

(22) Filed: May 12, 2025

(30) Foreign Application Priority Data
May 13, 2024 (JP) 2024-077712

(51) Int. Cl. G03G 15/00; G03G 15/22

(52) U.S. Cl. CPC G03G 15/5012; G03G 15/228; G03G 15/5016

(57) ABSTRACT

An image forming apparatus includes an image forming portion, an acquisition processing portion, and a display processing portion. The image forming portion forms a target image on a sheet. The acquisition processing portion acquires a sheet image obtained by reading the sheet. The display processing portion superimposes the target image on the sheet image and displays the target image and the sheet image as a preview screen.

### INCORPORATION BY REFERENCE

This application is based upon and claims the benefit of priority from the corresponding Japanese Patent Application No. 2024-077712 filed on May 13, 2024, the entire contents of which are incorporated herein by reference.

This disclosure relates to an image forming apparatus and an image forming method.

### BACKGROUND

As the related art, an electrophotographic image forming apparatus such as a digital copying machine has been known that irradiates a uniformly charged photosensitive layer of a photoconductor with light for exposure to form a latent image, attaches toner to the photosensitive layer having this latent image formed thereon for development, and transfers this to a sheet (paper sheet) for image formation.

The image forming apparatus according to the related art includes an image forming portion that forms an image on a sheet on the basis of image data stored in a storage means, a post-processing portion that performs a post-process on the sheet having the image formed thereon, and a setting means that sets an image formation condition including the post-process. This image forming apparatus further includes an image processing means that generates a thumbnail image and a display portion that displays the thumbnail image. The thumbnail image is an image that is generated from the image data and setting information about the image formation condition including the post-process set by the setting means and indicates the final output form of a sheet including the post-process. This allows a user to recognize the form of the output of the image forming apparatus and reduce miscopying.

### SUMMARY

An image forming apparatus according to an aspect of this disclosure includes an image forming portion, an acquisition processing portion, and a display processing portion. The image forming portion forms a target image on a sheet. The acquisition processing portion acquires a sheet image obtained by reading the sheet. The display processing portion superimposes the target image on the sheet image and displays the target image and the sheet image as a preview screen.

An image forming method according to another aspect of this disclosure includes forming a target image on a sheet, acquiring a sheet image obtained by reading the sheet, and superimposing the target image on the sheet image and displaying the target image and the sheet image as a preview screen.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing external appearance and an internal configuration of an image forming apparatus according to an embodiment 1.

FIG. 2 is a schematic block diagram of the image forming apparatus according to the embodiment 1.

FIG. 3 is a schematic diagram showing that the image forming apparatus according to the embodiment 1 forms a target image on a sheet.

FIG. 4 is a schematic diagram showing that the image forming apparatus according to the embodiment 1 generates a preview screen.

FIG. 5 is a flowchart showing an operation example of the image forming apparatus according to the embodiment 1.

### DETAILED DESCRIPTION

Hereinafter, an embodiment of this disclosure will be described with reference to the accompanying drawings. The following embodiment is a specific example of this disclosure and does not intend to limit the technical scope of this disclosure.

### Embodiment 1

### [1] Overall Configuration of Image Forming Apparatus

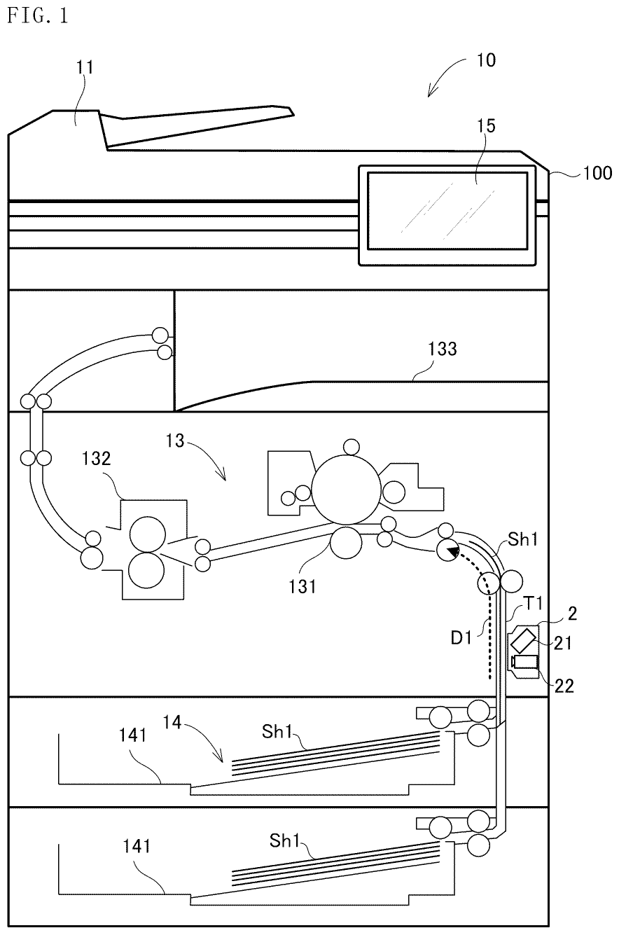

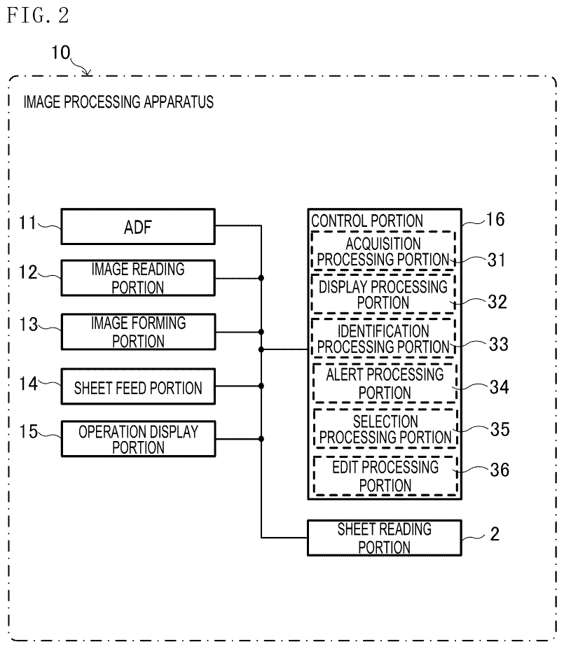

First, the overall configuration of an image forming apparatus 10 according to this embodiment will be described with reference to FIGS. 1 and 2.

The perpendicular direction viewed with the image forming apparatus 10 placed in an installation state (state shown in FIG. 1) that allows the image forming apparatus 10 to be used is defined as an up-down direction for the convenience of description. In addition, the direction of the image forming apparatus 10 shown in FIG. 1 orthogonal to FIG. 1 is defined as a front-rear direction. The surface of the image forming apparatus 10 on the foreground side of FIG. 1 is defined as a front (front surface). Furthermore, a left-right direction is defined on the assumption that the surface of the image forming apparatus 10 on the left side of FIG. 1 is a left surface.

As an example, the image forming apparatus 10 according to this embodiment is a multifunction peripheral having a plurality of functions such as a scan function of acquiring an image (image data) from a document sheet, a print function of forming an image on the basis of the image data, a facsimile function, and a copy function. It is sufficient if the image forming apparatus 10 has at least a function of forming an image (image forming function). The image forming apparatus 10 may be a printer, a facsimile apparatus, a copier, and the like.

As shown in FIGS. 1 and 2, the image forming apparatus 10 includes an automatic document sheet conveying device 11, an image reading portion 12, an image forming portion 13, a sheet feed portion 14, an operation display portion 15, a control portion 16, and a sheet reading portion 2. The automatic document sheet conveying device 11 is an auto document feeder (ADF). The automatic document sheet conveying device 11 is thus described as an “ADF” in FIG. 2 and will also be referred to as the “ADF 11” in the following description. In this embodiment, as shown in FIG. 1, the image forming apparatus 10 includes a housing 100. The ADF 11, the image reading portion 12, the image forming portion 13, the sheet feed portion 14, the operation display portion 15, the control portion 16, and the sheet reading portion 2 are provided in the housing 100.

The ADF 11 conveys a sheet (document sheet) an image on which is read by the image reading portion 12. The ADF 11 includes a document sheet set portion, a plurality of conveying rollers, a document sheet holder, a sheet discharge portion, and the like.

The image reading portion 12 reads an image from a sheet and outputs image data corresponding to the read image. The image reading portion 12 includes a document sheet table, a light source, a plurality of mirrors, an optical lens, a charge coupled device (CCD), and the like.

The image forming portion 13 forms an image on a sheet Sh1 (see FIG. 1) on the basis of the image data output from the image reading portion 12. In addition, the image forming portion 13 forms an image on the sheet Sh1 on the basis of image data input from an information processing apparatus such as a personal computer outside the image forming apparatus 10. In this embodiment, as an example, the image forming portion 13 includes a transfer device 131, a fixing device 132, a sheet discharge tray 133, and the like as shown in FIG. 1, and forms an image on the sheet Sh1 by electrophotographic printing. The image forming portion 13 is not limited to a configuration in which the image forming portion 13 forms a monochrome image. The image forming portion 13 may also be configured to form a full-color image by using the four colors of C (cyan), M (magenta), Y (yellow), and K (black). In addition, for example, the image forming portion 13 may be configured to form an image on a sheet in an image forming method such as an ink-jet method other than electrophotography.

The image forming portion 13 forms an image on the sheet Sh1 by using toner serving as a developer. Specifically, the image forming portion 13 irradiates a charged surface of a photoconductor drum with laser light to form an electrostatic latent image and develops the electrostatic latent image by using toner to form a toner image on the surface of the photoconductor drum. The transfer device 131 transfers the toner image to the sheet Sh1 conveyed in a conveyance path T1 (see FIG. 1). The fixing device 132 fuses and fixes the toner image transferred to the sheet Sh1 onto the sheet Sh1. For example, the fixing device 132 includes a fixing roller and a pressure roller. The fixing device 132 heats the toner image transferred to the sheet Sh1 and pressurizes the sheet Sh1 to fix the toner image onto the sheet Sh1. The sheet Sh1 having an image formed thereon is discharged to the sheet discharge tray 133. In a case where the image forming portion 13 forms an image in an ink-jet method, ink (another example of the developer) is supplied instead of toner.

A “sheet” according to this disclosure is the sheet Sh1 serving as a target on which a target image is formed by the image forming portion 13. The sheet Sh1 is paper as an example in this embodiment, but is not limited to paper. For example, the sheet Sh1 may be a resin film or the like.

The sheet feed portion 14 supplies the sheet Sh1 to the image forming portion 13. The sheet feed portion 14 includes a plurality of sheet feed cassettes 141, a manual feed tray, a plurality of conveying rollers, and the like. The sheet feed portion 14 conveys the sheets Sh1 from the plurality of sheet feed cassettes 141, the manual feed tray, or the like through the conveyance path T1 by the plurality of conveying rollers or the like and supplies the sheets Sh1 to the image forming portion 13. The image forming portion 13 forms an image on each of the sheets Sh1 supplied from the sheet feed portion 14 through the conveyance path T1.

The operation display portion 15 is a user interface in the image forming apparatus 10. The operation display portion 15 includes a display portion such as a liquid-crystal display that displays various types of information in response to a control instruction from the control portion 16 and an operation portion such as a switch or a touch panel that inputs various types of information to the control portion 16 in response to an operation of a user. In addition, the image forming apparatus 10 may include, for example, a sound output portion, a sound input portion, and the like as user interfaces in addition to or instead of the operation display portion 15.

The control portion 16 integrally controls the image forming apparatus 10. The control portion 16 is mainly composed of a computer system including one or more processor and one or more memories. In the image forming apparatus 10, the one or more processors execute a program, thereby achieving a function of the control portion 16. The program may be recorded in the one or more memories in advance, provided through an electric communication line such as the Internet, or recorded and provided in a non-transitory recording medium such as a memory card or an optical disc readable to the computer system. The one or more processors are each composed of one or more electronic circuits including a semiconductor integrated circuit. Furthermore, the computer system according to this disclosure includes a microcontroller including one or more processors and one or more memories. The control portion 16 may be a control portion provided separately from a main control portion that integrally controls the image forming apparatus 10.

As shown in FIG. 1, the sheet reading portion 2 includes a light irradiation portion 21 and an imaging portion 22. The light irradiation portion 21 emits illumination light to the surface of the sheet Sh1. In this embodiment, as an example, the light irradiation portion 21 includes one or more light emitting elements such as light emitting diodes (LEDs) or organic electroluminescence (EL) elements. The light irradiation portion 21 causes the whole of the light emitting surface having a rectangular shape in a plan view to emit light substantially uniformly for surface light emission. In this embodiment, as an example, the light irradiation portion 21 outputs visible light. Specifically, the light irradiation portion 21 outputs white light. It is, however, sufficient if the light irradiation portion 21 outputs light having a wavelength to which the imaging portion 22 has sensitivity. The light irradiation portion 21 may output light other than white light. For example, the light irradiation portion 21 may output light within the wavelength range of infrared light, ultraviolet light, or the like other than visible light.

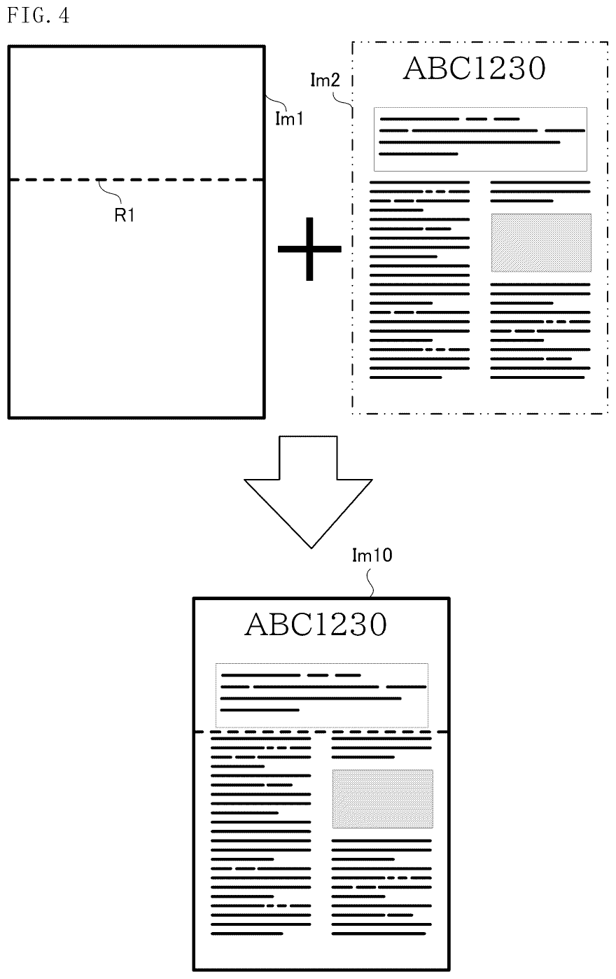

The imaging portion 22 captures an image of the surface of the sheet Sh1 as a sheet image Im1 (see FIG. 4). Here, it is an image of the sheet Sh1 irradiated with illumination light from the light irradiation portion 21 that the imaging portion 22 captures. At least at an imaging timing of the imaging portion 22, the light irradiation portion 21 emits illumination light. In this embodiment, as an example, the imaging portion 22 and the light irradiation portion 21 are synchronized. The light irradiation portion 21 emits illumination light in synchronization with the imaging timing of the imaging portion 22. That is, in a period in which the imaging portion 22 refrains from capturing an image, the light irradiation portion 21 outputs no illumination light. This prevents the light irradiation portion 21 from wasting power.

In this embodiment, the imaging portion 22 includes an imaging element such as an area sensor or a line sensor, and an optical part. The imaging portion 22 outputs the captured image data (sheet image Im1) of the sheet Sh1 to the control portion 16 as an electrical signal. In this embodiment, as an example, the imaging portion 22 is a contact image sensor (CIS)-type area sensor in which a complementary metal oxide semiconductor (CMOS) sensor is used as an imaging element. This example is not, however, limitative. The imaging portion 22 may be, for example, of a CCD type in which a charge coupled device (CCD) is used as an imaging element.

In this embodiment, as an example, the sheet reading portion 2 is stored in the housing 100 of the image forming apparatus 10 and electrically connected to at least the control portion 16. As shown in FIG. 1, in this embodiment, the sheet reading portion 2 including the light irradiation portion 21 and the imaging portion 22 is disposed to be opposed to the conveyance path T1 between the sheet feed portion 14 and the image forming portion 13. This allows the light irradiation portion 21 and the imaging portion 22 to emit illumination light to the sheet Sh1 being conveyed from the sheet feed portion 14 to the image forming portion 13 at a position between the sheet feed portion 14 and the image forming portion 13 and capture the sheet image Im1. If described in more detail, the sheet reading portion 2 is disposed at a position on the upstream side of the transfer device 131 of the image forming portion 13 and the downstream side of a merging point of the conveyance path T1 leading to the plurality of sheet feed cassettes 141 in a conveying direction D1 of the sheet Sh1. This also makes it possible to capture the sheet images Im1 by the one sheet reading portion 2 for the sheets Sh1 supplied from the plurality of sheet feed cassettes 141 to the image forming portion 13. It is not necessary to provide the sheet reading portion 2 for each of the sheet feed cassettes 141.

In addition, the image forming apparatus 10 further includes a storage portion, a communication portion, a power supply portion, and the like. The storage portion includes one or more non-volatile memories and stores, in advance, information about a control program or the like for causing the control portion 16 to execute various types of processes. The communication portion is an interface that executes data communication with an external apparatus connected to the image forming apparatus 10, for example, through a communication network such as the Internet or a local area network (LAN). The power supply portion is a power supply circuit that generates (outputs) power for bringing the image forming apparatus 10 into operation.

Incidentally, as the related art of this type of image forming apparatus 10, an electrophotographic image forming apparatus such as a digital copying machine has been known that irradiates a uniformly charged photosensitive layer of a photoconductor with light for exposure to form a latent image, attaches toner to the photosensitive layer having this latent image formed thereon for development, and transfers this to a sheet (paper sheet) for image formation.

The image forming apparatus according to the related art includes an image forming portion that forms an image on a sheet on the basis of image data stored in a storage means, a post-processing portion that performs a post-process on the sheet having the image formed thereon, and a setting means that sets an image formation condition including the post-process. This image forming apparatus further includes an image processing means that generates a thumbnail image and a display portion that displays the thumbnail image. The thumbnail image is an image that is generated from the image data and setting information about the image formation condition including the post-process set by the setting means and indicates the final output form of a sheet including the post-process. This allows a user to recognize the form of the output of the image forming apparatus and reduce miscopying.

However, in the configuration according to the related art described above, the state of a sheet on which an image is formed is not reflected in a thumbnail image. Therefore, for example, in a case where an image is formed, for example, on a sheet having a portion such as perforations at which an image is not to be formed, the image overlapping with the perforations or the like may lead to a mistake in image formation (such as miscopying).

In contrast, in this embodiment, a configuration described below achieves the image forming apparatus 10, an image forming method, and a program that are each less likely to lead to a mistake in image formation.

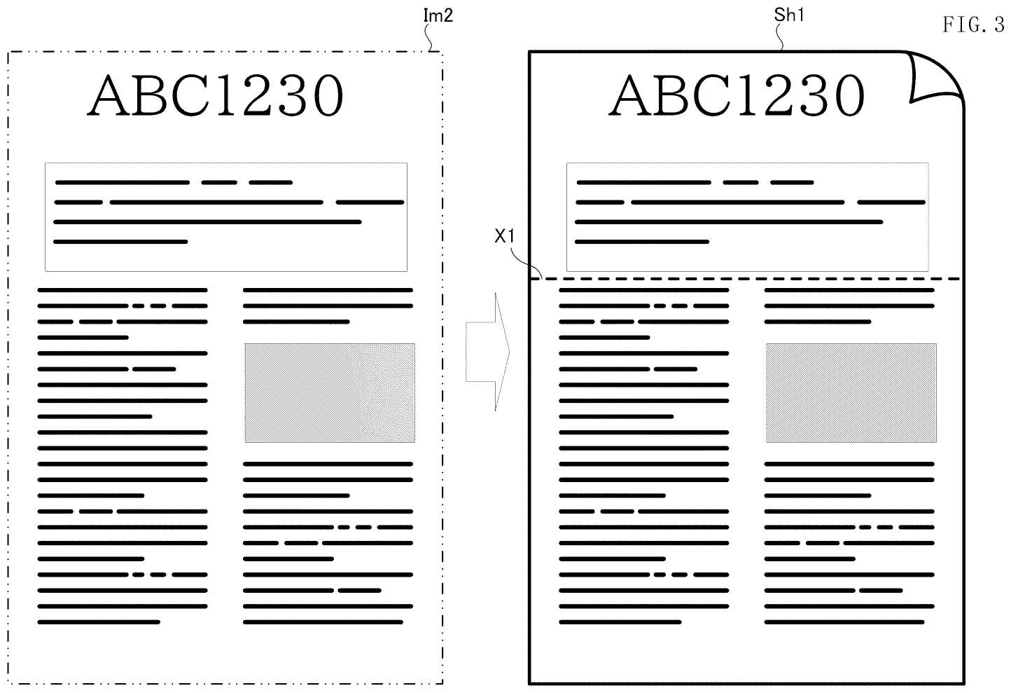

That is, as shown in FIG. 2, the image forming apparatus 10 according to this embodiment includes the image forming portion 13, an acquisition processing portion 31, and a display processing portion 32. The image forming portion 13 forms a target image Im2 (see FIG. 3) on the sheet Sh1. The acquisition processing portion 31 acquires the sheet image Im1 obtained by reading the sheet Sh1. The display processing portion 32 superimposes the target image Im2 on the sheet image Im1 and displays the target image Im2 and the sheet image Im1 as a preview screen Im10 (see FIG. 4). In this embodiment, the acquisition processing portion 31 and the display processing portion 32, which are components of the image forming apparatus 10, are each provided in the control portion 16 as a function of the control portion 16.

According to the configuration described above, it is possible to display the preview screen Im10 obtained by superimposing the target image Im2 formed on the sheet Sh1 on the sheet image Im1 obtained by reading the sheet Sh1. The preview screen Im10 like this is displayed to allow a user to confirm, in the preview screen Im10, the state of the sheet Sh1 having the target image Im2 formed thereon. Thus, for example, in a case where the target image Im2 is formed on the sheet Sh1 having a portion such as perforations at which an image is not to be formed, it is possible to confirm, in the preview screen Im10, whether or not the target image Im2 overlaps with the perforations or the like. As a result, this offers advantages that a mistake in image formation (such as miscopying) is less likely to be made by the target image Im2 overlapping with the perforations or the like.

### [2] Configuration of Control Portion

Next, respective functional portions included in the control portion 16 will be described in more detail with reference to FIG. 2.

As shown in FIG. 2, the control portion 16 includes the acquisition processing portion 31, the display processing portion 32, an identification processing portion 33, an alert processing portion 34, a selection processing portion 35, and an edit processing portion 36. That is, the image forming apparatus 10 includes the identification processing portion 33, the alert processing portion 34, the selection processing portion 35, and the edit processing portion 36 each as a function of the control portion 16 in addition to the acquisition processing portion 31 and the display processing portion 32.

The acquisition processing portion 31 acquires, from the sheet reading portion 2, the sheet image Im1 obtained by reading the sheet Sh1. Specifically, the acquisition processing portion 31 acquires the image data of the sheet image Im1 captured by the imaging portion 22 of the sheet reading portion 2 from the imaging portion 22 of the sheet reading portion 2 as an electrical signal. The acquisition processing portion 31 controls the light irradiation portion 21 and the imaging portion 22 and causes the sheet image Im1 to be captured, for example, in synchronization with a timing at which the sheet Sh1 passes the position corresponding to the sheet reading portion 2 in the conveyance path T1. The sheet image Im1 acquired by the acquisition processing portion 31 is temporarily stored in one or more memories. The acquisition processing portion 31 may acquire the sheet image Im1 from a portion other than the sheet reading portion 2.

It is possible for the display processing portion 32 to display the preview screen Im10, for example, on the operation display portion 15. The preview screen Im10 is an image obtained by superimposing the target image Im2 on the sheet image Im1 acquired by the acquisition processing portion 31. In this embodiment, as an example, it is assumed that an image read from a document sheet by the image reading portion 12 is copied (duplicated) by being formed on the sheet Sh1 by the image forming portion 13. The target image Im2 is therefore image data output from the image reading portion 12. This example is not, however, limitative. The target image Im2 may be, for example, image data received from an information processing apparatus such as a personal computer outside the image forming apparatus 10.

The identification processing portion 33 identifies a prohibition region R1 (see FIG. 4) in the sheet image Im1 in which the target image Im2 is prohibited from being formed. That is, for example, in the sheet Sh1 having a portion such as perforations at which an image is not to be formed, the perforations or the like serve as the prohibition region R1 for the sheet image Im1 obtained by reading the sheet Sh1 by the sheet reading portion 2. The identification processing portion 33 identifies the prohibition region R1 like this in the sheet image Im1. This makes it easier to determine, for example, in the preview screen Im10, whether or not the target image Im2 overlaps with the prohibition region R1 in which the target image Im2 is prohibited from being formed.

Here, the identification processing portion 33 identifies the prohibition region R1 in accordance with an operation of a user. In this embodiment, as an example, the identification processing portion 33 identifies the prohibition region R1 on the sheet image Im1 in accordance with an operation of a user on the operation display portion 15 with the sheet image Im1 displayed on the operation display portion 15. This allows the user to determine where the prohibition region R1 is set, for example, by looking at the sheet image Im1.

The alert processing portion 34 outputs an alert in a case where the target image Im2 overlaps with the prohibition region R1. The “alert” here includes, for example, notifying a user that the target image Im2 overlaps with the prohibition region R1 by displaying something (including displaying a screen, causing the light emitting portion to emit light, and the like) and/or outputting sound (including outputting a beep, outputting voice, and the like). Specifically, in a case where the target image Im2 overlaps with the prohibition region R1, the alert processing portion 34 causes, for example, the operation display portion 15 to display an alert screen. In contrast, if the target image Im2 does not overlap with the prohibition region R1, the alert processing portion 34 does not cause the alert screen to be displayed. This facilitates the user to notice that the target image Im2 is going to overlap with the prohibition region R1 in which the target image Im2 is prohibited from being formed.

The selection processing portion 35 selects continuing or suspending the formation of the target image Im2 in accordance with an operation of a user. In this embodiment, the selection processing portion 35 selects continuing or suspending the formation of the target image Im2 in accordance with an operation of a user in a case where the target image Im2 overlaps with the prohibition region R1 and an alert is output. Specifically, in a case where the target image Im2 overlaps with the prohibition region R1, the alert processing portion 34 displays, for example, on an alert screen displayed on the operation display portion 15, buttons that allow a user to select continuing or suspending the formation of the target image Im2. The selection processing portion 35 selects continuing or suspending the formation of the target image Im2 in accordance with an operation of the user on a button on the alert screen.

In a case where the selection processing portion 35 selects continuing the formation of the target image Im2, the image forming portion 13 continues the formation of the target image Im2 on the sheet Sh1. Meanwhile, in a case where the selection processing portion 35 selects suspending the formation of the target image Im2, the image forming portion 13 suspends the formation of the target image Im2 on the sheet Sh1. This makes it possible to continue or suspends the formation of the target image Im2 in accordance with an operation of a user, for example, in a case where the target image Im2 overlaps with the prohibition region R1 and an alert is output.

The edit processing portion 36 edits formation conditions regarding the formation of the target image Im2. The “formation conditions” according to this disclosure are various types of conditions used for the image forming portion 13 to form the target image Im2 on the sheet Sh1. The “formation conditions” according to this disclosure include, for example, the formation (print) position of the target image Im2, the size of the target image Im2, the space between lines and the font size in a case where the target image Im2 is text, and the like. For example, in a case where the target image Im2 overlaps with the prohibition region R1, an alert is output, and the selection processing portion 35 selects continuing the formation of the target image Im2, the edit processing portion 36 edits these formation conditions. This makes it possible to prevent the target image Im2 from overlapping with the prohibition region R1 by editing the formation conditions even in a case where the target image Im2 overlaps with the prohibition region R1 and an alert is output.

In addition, the edit processing portion 36 edits the formation conditions in accordance with an operation of a user. In this embodiment, as an example, the edit processing portion 36 edits the formation conditions in accordance with an operation of a user on the operation display portion 15 with the preview screen Im10 displayed on the operation display portion 15. For example, the formation conditions are edited to change the position of the target image Im2 with respect to the sheet image Im1 on the preview screen Im10. This makes it possible to prevent the target image Im2 from overlapping with the prohibition region R1.

### [3] Image Forming Method

Examples of procedures of the image forming method that is executed by the image forming apparatus 10 will be described below with reference to FIGS. 3 to 5.

The image forming method according to this embodiment is executed by the control portion 16. In other words, the image forming method is a method that is executed by the control portion 16 mainly composed of the computer system. Therefore, the program according to this embodiment is a program for causing the one or more processors (in the control portion 16) to execute the image forming method.

Here, as shown in FIG. 3, it is assumed that the target image Im2 read from a document sheet by the image reading portion 12 is copied (duplicated) by being formed on the sheet Sh1 by the image forming portion 13. The target image Im2 is image data output from the image reading portion 12 and is an image including text. In addition, it is assumed that the sheet Sh1 includes perforations X1 (perforated line) and the target image Im2 is prohibited from being formed on these perforations X1.

In a case where the target image Im2 is formed on the sheet Sh1 like this, a user has to grasp the position of the perforations X1 to set the sheet Sh1 and also form the target image Im2 while avoiding the perforations X1. However, it is normally unknown how the target image Im2 is going to be formed on the sheet Sh1 in many cases before the target image Im2 is actually formed (printed) on the sheet Sh1. Therefore, the target image Im2 overlapping with the perforations X1 sometimes leads to a mistake in image formation (such as miscopying). In addition, the user has to carry out trials many times. This sometimes decreases working efficiency.

In the image forming method according to this embodiment, the image (sheet image Im1) of the sheet Sh1 is read in advance, and the target image Im2 is superimposed on the sheet image Im1 and the target image Im2 and the sheet image Im1 are displayed as the preview screen Im10 as shown in FIG. 4 before the target image Im2 is formed on the sheet Sh1. That is, in the preview screen Im10, the target image Im2 is superimposed on the sheet image Im1 of the sheet Sh1 on which the target image Im2 has not yet been formed. This allows a user to confirm, by looking at the preview screen Im10, how the target image Im2 is going to be formed on the sheet Sh1 before the target image Im2 is actually formed (printed) on the sheet Sh1.

In short, as exemplified in FIG. 4, the target image Im2 that is a target for image formation is superimposed and displayed on the sheet image Im1 including the prohibition region R1 corresponding to the perforations X1 in the preview screen Im10. The preview screen Im10 therefore makes it possible to confirm how the target image Im2 is going to be formed on the sheet Sh1. For example, it is possible to confirm whether or not the target image Im2 is going to overlap with the perforations X1 (prohibition region R1).

The image forming apparatus 10 according to this embodiment has a “special paper sheet mode”, for example, as an operation mode for forming the target image Im2 on the sheet Sh1 having a portion such as the perforations X1 at which an image is not to be formed. It is sufficient if the preview screen Im10 as described above is displayed in the special paper sheet mode alone.

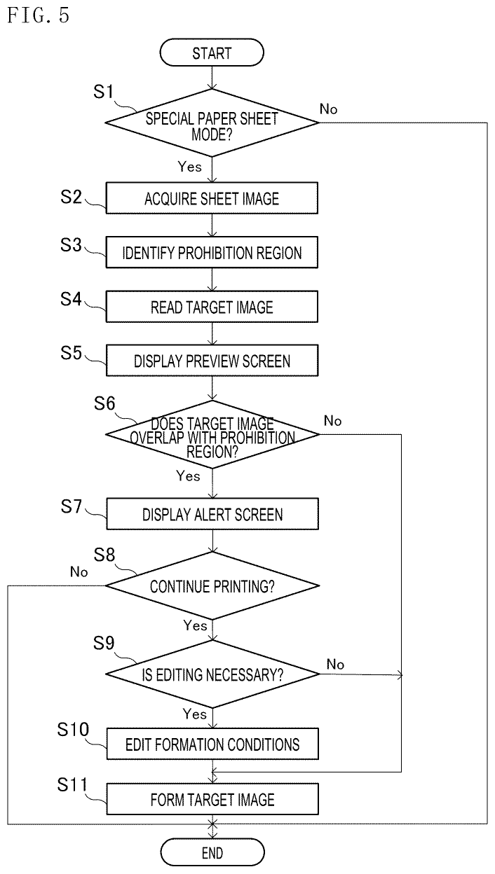

Details of the image forming method according to this embodiment will be described below with reference to the flowchart of FIG. 5. Here, steps S1, S2, . . . in the flowchart shown in FIG. 5 denote the numbers of processing procedures (steps) that are executed by the control portion 16.

### <Step S1>

First, the image forming apparatus 10 determines whether or not the special paper sheet mode is enabled (S1). For example, in a case where the target image Im2 is formed on the sheet Sh1 having a portion such as the perforations X1 at which an image is not to be formed, it is determined that the special paper sheet mode is enabled (S1: Yes) and the image forming apparatus 10 shifts the process to step S2. If the special paper sheet mode is not enabled (S1: No), the image forming apparatus 10 ends the series of processes shown in FIG. 5.

### <Step S2>

In step S2, an image of the sheet Sh1 before printing is read by the sheet reading portion 2 and the acquisition processing portion 31 acquires the sheet image Im1 from the sheet reading portion 2. The acquisition processing portion 31 stores the acquired sheet image Im1 in a memory.

### <Step S3>

In next step S3, on the basis of the sheet image Im1, the identification processing portion 33 identifies the prohibition region R1 such as the portion having the perforations X1 or the like in which the target image Im2 is prohibited from being formed. At this time, the identification processing portion 33 identifies the prohibition region R1 on the sheet image Im1 in accordance with an operation of a user on the operation display portion 15 with the sheet image Im1 displayed on the operation display portion 15. This example is not, however, limitative. The identification processing portion 33 may automatically identify the prohibition region R1 from the sheet image Im1.

### <Steps S4 and S5>

In step S4, the target image Im2 is read from a document sheet by the image reading portion 12. The display processing portion 32 generates the preview screen Im10 by superimposing the target image Im2 on the sheet image Im1 and causes the operation display portion 15 to display the preview screen Im10.

### <Step S6>

In next step S6, the alert processing portion 34 determines whether or not the target image Im2 overlaps with the prohibition region R1 in the preview screen Im10. In a case where the target image Im2 overlaps with the prohibition region R1 (S6: Yes), the alert processing portion 34 shifts the process to step S7. In a case where the target image Im2 does not overlap with the prohibition region R1 (S6: No), the alert processing portion 34 shifts the process to step S11.

### <Step S7>

In step S7, the alert processing portion 34 causes the operation display portion 15 to display an alert screen. The alert screen is a screen that notifies a user that the target image Im2 overlaps with the prohibition region R1, and includes at least the preview screen Im10. Furthermore, the alert processing portion 34 displays, on the alert screen, buttons that allow a user to select continuing or suspending the formation of the target image Im2.

### <Step S8>

In step S8, the selection processing portion 35 selects continuing or suspending the formation of the target image Im2. When a user who confirms the preview screen Im10 operates the button of “continue” on the alert screen at this time, the selection processing portion 35 selects continuing the formation of the target image Im2 (S8: Yes) and shifts the process to step S9. When the user operates the button of “suspend” on the alert screen, the selection processing portion 35 selects suspending the formation of the target image Im2 (S8: No) and the image forming apparatus 10 ends the series of processes shown in FIG. 5.

<Step S9>In step S9, the edit processing portion 36 determines whether or not the formation conditions need editing. When a user who confirms the preview screen Im10 makes an operation of “editing is necessary” on the alert screen at this time, the edit processing portion 36 determines that the formation conditions need editing (S9: Yes) and shifts the process to step S10. When the user makes an operation of “editing is unnecessary” on the alert screen, the edit processing portion 36 determines that the formation conditions do not need editing (S9: No) and shifts the process to step S11 to start to form the target image Im2 without editing the formation conditions.

### <Step S10>

In step S10, the edit processing portion 36 edits the formation conditions in accordance with an operation of a user on the operation display portion 15 with the preview screen Im10 displayed on the operation display portion 15. For example, the formation conditions such as the position of the target image Im2 with respect to the sheet image Im1, the size of the target image Im2, and the space between lines and the font size in a case where the target image Im2 is text are edited on the preview screen Im10 in accordance with an operation of a user.

Here, for example, in a case where editing the formation conditions results in a new error such as the target image Im2 sticking out of the sheet Sh1, the alert processing portion 34 displays an alert screen on the operation display portion 15 again and prevents a further mistake in image formation from being made.

### <Step S11>

In step S11, the image forming portion 13 forms the target image Im2 on the sheet Sh1.

The procedures of the image forming method described above are merely examples. The order of processes shown in the flowchart of FIG. 5 may be changed as appropriate or a process may be added.

For example, the display processing portion 32 determines an attribute of the sheet Sh1 from the sheet image Im1 and may display the preview screen Im10 in a case where the attribute satisfies a predetermined condition. As an example, only in a case where the attribute of the sheet Sh1 is, for example, the sheet Sh1 having a portion such as the perforations X1 at which an image is not to be formed, the preview screen Im10 is displayed on the assumption that the predetermined condition is satisfied. This makes it possible to automatically determine, by acquiring the sheet image Im1 before step S1, whether or not the special paper sheet mode is enabled on the basis of the sheet image Im1.

In addition, in a case where a user sets the wrong sheet Sh1, the user is able to recognize, in the preview screen Im10 displayed in step S5, that the sheet Sh1 which is not suited to the target image Im2 is set. In this case, the series of processes may be ended to cancel the formation of the target image Im2 at the time point of step S5. Alternatively, the process may be continued by setting the correct sheet Sh1 again and acquiring the sheet image Im1 (S2) alone again.

In addition, in the special paper sheet mode, the plurality of sheet images Im1 may be registered in advance and the acquisition processing portion 31 may acquire the one sheet image Im1 selected from the plurality of sheet images Im1 instead of reading the sheet image Im1 every time.

### [4] Modification

The plurality of components included in the image forming apparatus 10 may be distributed and provided in a plurality of housings. For example, the acquisition processing portion 31, the display processing portion 32, the identification processing portion 33, and the like are not limited to the configuration in which they are each achieved as a function of the control portion 16. The acquisition processing portion 31, the display processing portion 32, the identification processing portion 33, and the like may be provided in a different housing from the housing of the control portion 16. That is, for example, at least some of the acquisition processing portion 31, the display processing portion 32, the identification processing portion 33, and the like do not have to be integrated with the housing 100 of the image forming apparatus 10 and may be provided in a different housing.

In addition, the sheet Sh1 from which the sheet image Im1 is read is not limited to a sheet being conveyed. For example, the sheet Sh1 from which the sheet image Im1 is read may be the sheet Sh1 or the like set in the sheet feed cassette 141. In this case, the sheet reading portion 2 is disposed above the sheet feed cassette 141.

### [Supplementary Notes of Invention]

The gist of the invention extracted from the embodiment described above will be supplementarily noted below. It is noted that the respective configurations and the respective processing functions described in the following supplementary notes can be sorted out and used in any combination.

### <Supplementary Note 1>

An image forming apparatus including:
an image forming portion configured to form a target image on a sheet;
an acquisition processing portion configured to acquire a sheet image obtained by reading the sheet; and
a display processing portion configured to superimpose the target image on the sheet image and display the target image and the sheet image as a preview screen.

### <Supplementary Note 2>

The image forming apparatus according to Supplementary Note 1, further including an identification processing portion configured to identify, in the sheet image, a prohibition region in which the target image is prohibited from being formed.

### <Supplementary Note 3>

The image forming apparatus according to Supplementary Note 2, in which the identification processing portion identifies the prohibition region in accordance with an operation of a user.

### <Supplementary Note 4>

The image forming apparatus according to Supplementary Note 2 or 3, further including an alert processing portion configured to output an alert in a case where the target image overlaps with the prohibition region.

### <Supplementary Note 5>

The image forming apparatus according to any of Supplementary Notes 1 to 4, further including a selection processing portion configured to select continuing or suspending formation of the target image in accordance with an operation of a user.

### <Supplementary Note 6>

The image forming apparatus according to any of Supplementary Notes 1 to 5, further including an edit processing portion configured to edit a formation condition regarding formation of the target image.

### <Supplementary Note 7>

The image forming apparatus according to Supplementary Note 6, in which the edit processing portion edits the formation condition in accordance with an operation of a user.

### <Supplementary Note 8>

The image forming apparatus according to any of Supplementary Notes 1 to 7, in which the display processing portion determines an attribute of the sheet from the sheet image and displays the preview screen in a case where the attribute satisfies a predetermined condition.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to form a target image on a sheet;
an acquisition processing portion configured to acquire a sheet image obtained by reading the sheet; and
a display processing portion configured to superimpose the target image on the sheet image and display the target image and the sheet image as a preview screen.

2. The image forming apparatus according to claim 1, further comprising an identification processing portion configured to identify, in the sheet image, a prohibition region in which the target image is prohibited from being formed.

3. The image forming apparatus according to claim 2, wherein the identification processing portion identifies the prohibition region in accordance with an operation of a user.

4. The image forming apparatus according to claim 2, further comprising an alert processing portion configured to output an alert in a case where the target image overlaps with the prohibition region.

5. The image forming apparatus according to claim 1, further comprising a selection processing portion configured to select continuing or suspending formation of the target image in accordance with an operation of a user.

6. The image forming apparatus according to claim 1, further comprising an edit processing portion configured to edit a formation condition regarding formation of the target image.

7. The image forming apparatus according to claim 6, wherein the edit processing portion edits the formation condition in accordance with an operation of a user.

8. The image forming apparatus according to claim 1, wherein the display processing portion determines an attribute of the sheet from the sheet image and displays the preview screen in a case where the attribute satisfies a predetermined condition.

9. An image forming method comprising:
forming a target image on a sheet;
acquiring a sheet image obtained by reading the sheet; and
superimposing the target image on the sheet image and displaying the target image and the sheet image as a preview screen.
